(19) United States
(12) Patent Application Publication
(10) Pub. No.: US 2007/0144054 A1
(43) Pub. Date: Jun. 28, 2007

(54) Plastic fishing lure having porous particles

(76) Inventors: Daniel Joseph Warczok, Cohocton, NY (US); Ronald Joseph Boyce, Rochester, NY (US)

Correspondence Address: HISCOCK & BARCLAY, LLP, 2000 HSBC PLAZA, 100 Chestnut Street, ROCHESTER, NY, 14604-2404, US

(21) Appl. No.: 11/317,877

(22) Filed: Dec. 22, 2005

(51) Int. Cl. A01K 85/01

(52) U.S. Cl. 43/42.06; 43/42.24

(57) ABSTRACT

The invention is a soft bait composition that is loaded with a quantity of porous particles, such as calcium carbonate satu rated with aqueous based or oil based fish attractant, which is released over several hours while immersed in water. Furthermore, the porous particles can provide a wide range of sink rates in plastic fishing lures.

### FIELD OF THE INVENTION

The present invention relates to the field of fishing lures, and more particularly, adding porous inorganic or polymeric particles to said bait, thus increasing density and ability to absorb and release fish-attracting materials.

### BACKGROUND OF THE INVENTION

Fishing is an art and way of life enjoyed by many as a recreational sport or as a commercial enterprise. Sport fisherman or recreational anglers still use the time-proven method of dropping a baited hook attached to a line into the water in the hopes of catching a fish. Through modern advances, anglers now have a wide assortment of equipment with which to find and catch fish.

To encourage the fish to bite, the hook may be baited with a tempting morsel of food such as a live bait fish, live worm, roe, or other live bait that is part of the natural diet of the fish species sought by the angler. Anglers also may use a fishing lure, which is a manufactured artificial bait that mimics the look and action of the natural bait. Although the dietary choices of most fish can be extremely fickle, part of the attraction of fishing is attempting to discern not only where the fish are located, but also the type of bait that the fish are interested in eating. When bait fish are not available to the angler, or the use of bait fish is forbidden by local laws, anglers often use fishing lures to catch fish. Fishing lures are used by anglers in both salt water and fresh water.

There is a large variety of lures available to fishermen. A number of them have been patented. The following is a partial listing of U.S. patents and published applications covering various types of lures.

U.S. Pat. No. 2,572,608 discloses a worm shaped lure made of rubber and having the same look and feel as that of a natural worm. A slit opening is included for the insertion of a hook. The rubber materials used by such lures are meant to simulate the look and feel of a natural worm.

U.S. Pat. No. 2,776,518 discloses a fish lure which comprises a molded plastic body, including a head section, an intermediate section and a deformable tail section, having a longitudinal bore there through, a rod extending through the bore, a fishhook secured to the rod at the tail section, a swivel secured to the rod at the head section and a weight embedded within the body.

U.S. Pat. No. 4,993,183 discloses banana oil impregnated plastic fishing lures which are provided in various sizes, shapes, colors and resiliency, in order to increase the lure retention time in the mouth of a fish during a strike. In a preferred embodiment the banana oil is impregnated in the plastic fishing lures by mixing the oil into the plastisol while the plastisol is in a liquid state. The concentration of banana oil utilized may be any concentration which is sufficient to impart a banana flavor to the plastic fishing lures. The banana oil may also be added topically to the fishing lures either prior to or after packaging.

U.S. Pat. No. 5,956,888 discloses a glitter fishing lure formed from a liquid plastisol in which a vinyl resin has been dispersed in primary and secondary plasticizers. The primary plasticizer is an adipate or phthalate ester, the secondary plasticizer is a hydrocarbon, and the weight ratio of the primary to secondary plasticizer is preferably at least about 1.5, and more preferably about 5.25. The plastisol is heated to at least about its fusion temperature, and shaped in a mold to form a lure body. Once the lure body has cooled and hardened, it has a tacky outer surface. The lure body is agitated in the presence of thermoplastic first glitter flakes under dry conditions, so that the first glitter flakes adhere to the tacky outer surface of the lure body.

U.S. Pat. No. 6,061,948 discloses a mountable head that is adapted to be fitted or coupled to a presently existing or common fishing lure, such as a worm and hook fishing lure or a fly fishing lure. The mountable head comprises a head portion having a hollow receiving chamber and attaching components coupled thereto. The attaching components are depressed or bent inwardly into the receiving chamber so that they are in engaging positions. Various colored eyes are painted on or fixedly attached to different head portions to resemble the heads and eyes of bait animals upon which fish prefer to prey. The attaching components aid in securing the head portion to a fishing lure and further aid in securing the body portion of a soft plastic animal fishing lure in place to a fishing hook, thus preventing the body portion from sliding down the shank of the hook. An eyelet access opening is provided on the head portion to allow access to the eyelet of a fishing lure hook so that a fishing line is able to be attached thereto. The mountable head allows a fishing person or angler to easily alter the appearance and attractiveness of a presently existing or common fishing lure by simply interchanging the mountable head so that the lure has a different head and eye color combination. A weight portion is coupled to the head portion.

U.S. Pat. No. 6,266,916 discloses a fishing lure molded of flexible, translucent, soft plastic material into an integral unit in the form of a baitfish. Pigments, glitter, scent and flavor additives are mixed with the plastic during manufacture to create realistic visual, smell and taste characteristics. A wide gap offset fish hook is removably attached and substantially hidden in the lure by a hook slot in the lower longitudinal edge of the lure, and by an internal chamber. The internal chamber further serves to allow the body of the lure to collapse when attacked by a fish, exposing the point of the hook, as well as to conceal tube weights, flotation inserts, trap air contributing to the buoyancy and upright positioning of the lure, and to act as a reservoir for liquid fish attractant. The buoyancy and sink rate of the lure can be manipulated by utilizing various combinations of hook sizes, tube weight sizes, and flotation inserts positions into the internal chamber. Realistic movement of the lure is attained through the buoyancy and flexibility of the plastic material, the hydrodynamics of the design, and through rod, reel and fishing line manipulation by the angler.

U.S. Pat. No. 4,927,643 issued to V. T. D'Orazio, et al is directed to a water-soluble polymer fishing lure coating having an odoriferous fish-attractant material dispersed therein. A composition for application on the fishing lures to provide olfactory stimulation of fish includes a volatile organic solvent, a polymeric material dissolved in the solvent and capable of forming a water-soluble coating, and a fish attractant material dispersed in the solution. A method for imparting an olfactory stimulus to a fishing lure includes applying said composition onto the lure, preferably by spraying, dipping or brushing, and then exposing the lure to air for volatilization of the organic solvent and deposition of the coating.

U.S. Pat. No. 4,742,638 issued to D. J. Vobejda is directed to an artificial hollow body fishing lure which provides a means for containing a liquid scent and dispensing that scent in metered amounts as the lure is drawn through the water. The lure contains a propeller at its rear end which turns as the lure is pulled through the water. Turning of the propeller conveys the liquid scent contained within the hollow lure and disperses it into the water to attract fish to the lure.

U.S. Pat. No. 4,463,018 issued to W. E. S. Carr is directed to an artificial bait comprised of a tough, semi-rigid, flexible water-insoluble matrix material formed of hydrophilic macromolecular substances containing therein a fish attractant. The Carr baits are designed for placing on a hook and fishing in the same manner as is done with non-live natural baits.

U.S. Pat. No. 3,359,114 issued to F. Witteman, et al is directed to a composition for use as a fishing lure by attachment to a fishing hook. This composition contains a quantity of minute, buoyant, hollow microspheres, e.g., hollow glass microspheres, which are dispersed in a normally non-buoyant fishing bait material to produce sufficient buoyancy to cause the fish lure composition with hook to float. Suitable disclosed normally non-buoyant fishing bait materials are Velveeta cheese, American cheese, hamburger, and mashed salmon eggs.

U.S. Pat. No. 3,684,519 issued to E. S. Combs is directed to a fish bait made of comminuted organic tissue particles dispersed in a solidified polyacrylamide gel. When stored out of contact with water, the gel tightly compacts around the tissue particles and allegedly prevents biological degradation of the tissue. When immersed in water the gel swells to allow bacterial action to take place in the tissue. The tissue odor is released through the surrounding gel in the same manner as from tissue alone, and the gel is disclosed as protecting the tissue from decomposition.

U.S. Pat. No. 3,987,575 issued to T. Morita is directed to a fishing lure or plug device which contains self-chumming means for attracting fish to the lure for biting thereon. The lure is shaped like a bait fish or any usual shape of fish lure, spoon or the like, and has hooks attached to it, an eyelet means for attachment to a leader line to the fisherman or his reel. The lure body has a chamber formed therein for receiving a liquid container in the form of a vial or capsule containing a liquid such as fish oil, cod liver oil, or other fish-derived oil which is attractive to the fish being sought, the chamber being open at one or both ends with a retaining spring to retain the oil capsule therein, so that by puncturing the vial or capsule, the oil is dribbled out and entrained with the water to attract the fish.

U.S. Pat. No. 4,875,305 issued to J. O. Bridges is directed to a fishing lure having a fish-attractant body which is formed of a water-soluble polymer having a slow dissolution rate. The polymer contains a fish scent attractant which can be encapsulated, viz., trapped, within the polymer, e.g., fish or blood meal can be included in the polymer so that it will be slowly dispensed into the water as the polymer dissolves. The preferred polymer is polyvinyl alcohol having a pre-selected degree of hydrolysis of its ester groups to achieve the desired water-solubility rate, and optionally plasticized with glycerol. The attractant can be a sheet which has a plurality of parallel and co-extensive slits to provide parallel strips that depend from an unslit portion thereby permitting the sheet material to be wrapped about a lure body and secured in place so that the parallel strips extend rearly from the body, permitting them to undulate in the water as the lure is pulled through the water, simulating the swimming movements of a small fish. [Note FIG. 3]. Other embodiments include solid form lures shaped from polyvinyl alcohol which is gelled with a soluble borate.

For centuries anglers have employed live or dead bait prey to enhance their catch rates of gamefish. By using live, dead, or sundry body parts of various prey species as bait, anglers have enticed gamefish to strike their presentations. There was little scientific investigation into the reasons behind the effectiveness of these natural food sources.

More recently, the industry has sought synthetic fish attractants to reduce the costs while increasing the convenience and storage stability of the baits. Fish attractants have come in many different forms. Early attractants were designed as dipping solutions that adhered to the outer surface of an artificial lure. Later, the art evolved toward the use of a stimulant that was molded into the lure body. Such molded compositions released the stimulant in a more controlled rate and exhibited both higher efficacy for longer periods with better ease of use.

The use of sodium chloride in soft plastic baits dates back to at least 1981. The rationale accepted by most anglers is that fish find salt appealing, like humans. The taste of sodium chloride, the reasoning goes, causes gamefish to retain salt-containing lures for longer period. This longer retention time should result in a higher probability of setting the hook with an overall increase in the catch rate (ratio of bites to recovered fish). See, Larew U.S. Pat. No. 4,530,179.

Standard, non-iodized table salt is the common component in salted baits. It is an inexpensive component, readily understood in terms of the human taste experience, and has generated some scientific evidence that some fish species are sensitive to sodium chloride. Further, sodium chloride increases the density of the lure so that an additional weight, such as a lead weight, is not needed to prevent the lure from floating on the surface of the water. However, sodium chloride is not porous and does not readily absorb fish attractants. Therefore, there exists a need for a bait that combines the ability to sink at various calculated rates without a metallic weight and the potential to absorb and release natural or artificial gustatory stimulants for fishing lures.

### SUMMARY OF THE INVENTION

It is an objective of the present invention to provide a mechanism for sustained release of water soluble and oil soluble fish attractants, and provide a plastic fishing lure that offers increased sink rates as a function of density. It is an objective of the present invention to provide a plastisol-based fishing lure that involves porous inorganic or synthetic particles in the molding process.

In accordance with these and other objectives of the invention that will become apparent from the description herein, to provide an artificial fishing lure comprising a cured polymer in the shape of a fish-attracting artificial fishing lure made from a composite material comprising: a polymeric base material and a portion of porous inorganic or synthetic particles, such as particulate calcium carbonate, that is dispersed throughout said polymeric body with a weight ratio in the range of 0.01:1 to 8:1.

Artificial, plastisol-based fishing lures that may contain a particular fish-attractant absorbed into the dispersed porous particles are preferably molded into a shape suggestive of a fish-attracting bait, and cured. The molding and curing conditions will generally follow conventional conditions that depend on the nature of the polymer and whose particular conditions are readily determinable by those with no more than the existing level of skill in the art.

For instance, a soft gelatinous elastomer composition and article useful as fishing bait formed from one, or a mixture of two or more, of a hydrogenated styrene isoprene/butadiene block copolymer(s). and one or more plasticizers being in sufficient amounts to achieve a gel rigidity of from about 20 gram Bloom to about 1,800 gram Bloom.

This invention relates to fishing tackle, and more particularly, to artificial fishing lures. it is believed that soft bodied fishing lures feel relatively lifelike to game fish, so the striking fish will usually hold a soft lure longer in its mouth than the fish would hold a hard bodied lure. This allows the fisherman additional time to recognize the strike and set a hook in the fish's mouth.

Fishing baits made from the invention materials may use PVC soft plastic. Since the molten temperature of the invention is much higher than that required to melt PVC plastisol, the releasable fish-attracting materials may be incorporated after the formation of the material by soaking or dipping the bait articles in a solution containing the attractant. Alternatively, the bait articles may be sprayed with the attractant.

Other water soluble fish attractants are solids that can also be used or mixed with the porous inorganic or synthetic particles and dispersed in the polymeric body of the present invention. Other lures are of the type wherein the fish attractant material is distributed throughout a matrix of water-soluble polymer material, for example, by being molded therein, to allow for release of such fish attractant into the water upon dissolution of the polymer matrix, thereby resulting in leeching out of the fish attractant. The water-soluble polymer may be, for example, a polyvinyl alcohol having a pre-selected degree of hydrolysis of its ester groups to achieve the desired water-solubility rate, and optionally plasticized with glycerol or a polyvinyl alcohol which is gelled with a soluble borate. Similarly, the particles may be dispersed in a polymer gel, such as solidified polyacrylamide gel, that expands instead of dissolving in water.

Shortcomings in the art, such as the untimely release of scent and inadequately slow sink rates, are by and large eliminated in accordance with the present invention. The invention offers a combination of both a timely release of fish-attractant scent and a range of densities allowing the user a wide range of options depending on the different conditions faced in the fishing endeavor. The proximity of the particles to the surface of the bait will determine the rate at which the fish-attracting materials are released. The invention is practical and effective in use for as long as several hours.

A variety of vinyl resins and vinyl plastisols can be used in accordance with this invention, for example: low molecular weight polyvinyl chloride; medium molecular weight polyvinyl chloride; blends of low and medium molecular weight polyvinyl chloride, and equivalent vinyl plastisols. Alternatively, natural and synthetic rubbers may be used in place of the plastisol, as may thermosetting synthetic plastics.

Characteristically, these vinyl plastisols are heavily plasticized, e.g., contain from about thirty to about 65 percent by weight, based on total vinyl plastisol formulation, of a plasticizer, such as, dioctyl phthalate, dicapryl phthalate, dioctyl adipate, dioctyl sebacate, mixtures of any two or more of such plasticizers, etc. Alternatively, the plastisol includes any amount of plasticizer to achieve the desired polymeric characteristics, such as flexibility.

Stabilizers, fillers, pigments, gel thixotropic agents, solvents, flow control agents, lubricants, and other customary additives can be used in accordance with the known molding techniques of such plastisols, e.g., injection molding, rotational molding, hand pouring, etc.

The particles may be composed of, but not limited to, the following: calcium carbonate, clays (such as cat litter), vermiculite, pumice, sponge, and polymers composed of polyacrylate or polyacrylamide and their respective salt species. The particles may or may not be laden with fish-attracting scents depending on the fishing application being addressed. When used, such fish-attracting scents could be composed of natural or synthetically based materials.

### DESCRIPTION OF FIGURES

FIGS. 1-4 show examples of baits having specific shapes, which may be produced based on the conditions of the invention. The baits in FIGS. 1-4 are, respectively, a crab, a worm, a frog chunk, and a lizard. It should not be concluded that this invention is limited to shown baits. The bait 101 may be made completely from the plastic material and may optionally include a hook 102.

FIG. 5 is a worm-type bait having an unevenly-distributed amount of porous particles. The porous particles are more heavily concentrated on the right side of the figure.

FIGS. 6 and 7 are cross-sectional views of the invention having varying amounts of particulate contained therein.

### DETAILED DESCRIPTION OF THE INVENTION

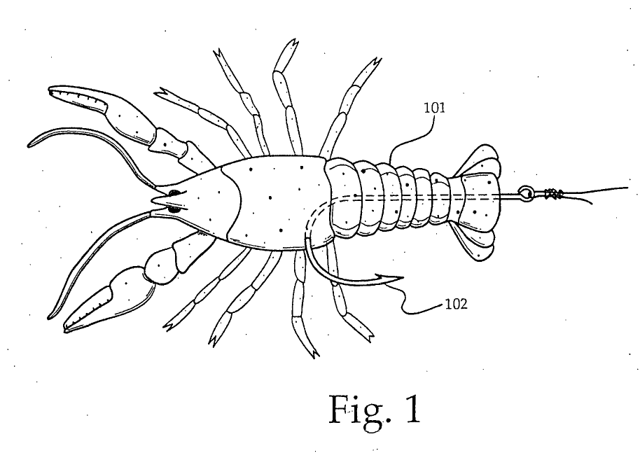

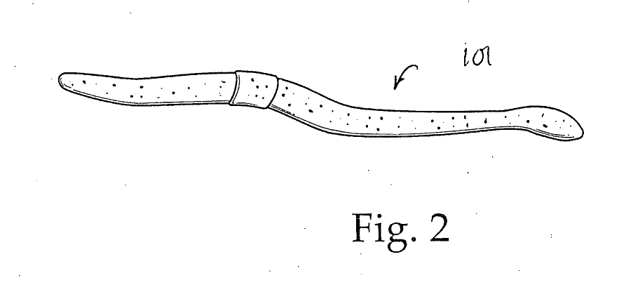

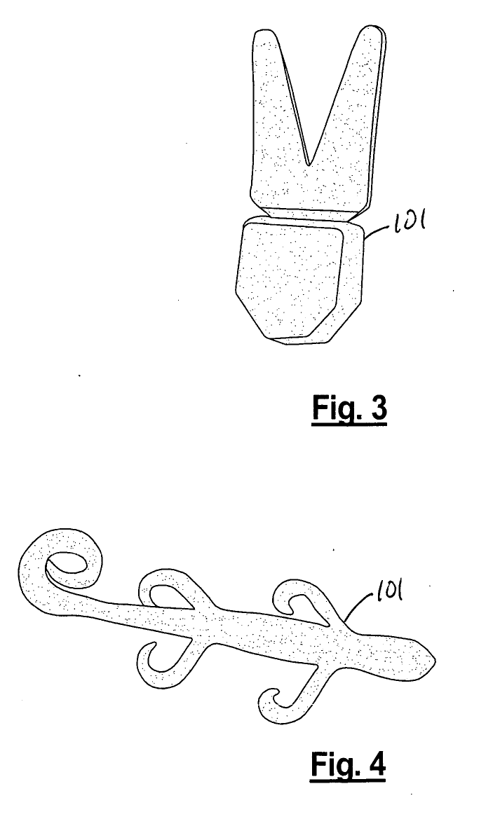

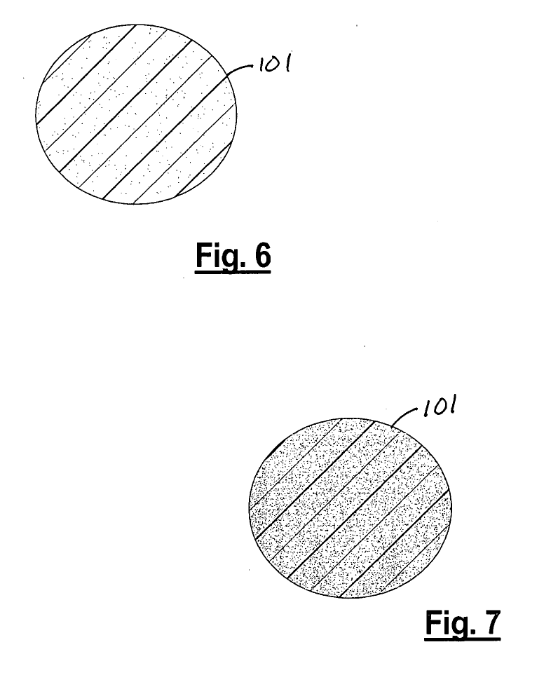

The artificial lure of the invention is provided in a variety of fish attracting forms, such as a worm, crayfish, minnow, crab, lizard, a frog chunk, and others. Examples of the forms of the lure 101 are shown in FIGS. 1-6. FIG. 1 shows a lure 101 having a hook 102. The lure 101 is formed of a soft polymer such as one of a variety of vinyl resins and vinyl plastisols; for example: low molecular weight polyvinyl chloride; medium molecular weight polyvinyl chloride; blends of low and medium molecular weight polyvinyl chloride; and equivalent vinyl plastisols. Alternatively, the lure 101 comprises another soft, flexible polymer or a substantially rigid plastic.

A plurality of porous inorganic or synthetic particles are interspersed throughout the polymeric base material of the lure 101. The porous particles may comprise materials including, but not limited to, calcium carbonate, clays (such as cat litter), vermiculite, pumice, sponge, and polymers composed of polyacrylate or polyacrylamide and their respective salt species. The size of the porous particles may be on the order of 0.1 to 2000 microns, preferably 50 to 1000 microns.

The porous particles are provided to increase the density, and thus the sink rate, of the lure 101 and to readily absorb a fish attractant. The ratio of the weight of the porous particles to the weight of the polymeric base material ranges from 0.01:1 to 8:1. A lower ratio, such as the one shown by the cross-section in FIG. 7, exhibits a slower sink rate and a smaller capacity for fish attractant than one with a high ratio, such as the one shown by the cross-section in FIG. 8.

The fish attractant is selected from any of a number of well known natural and synthetic fish attractants, such as cod liver oil, menhaden oil, oils from other oily fish, crayfish extracts, worm extracts or various scents or oils from either natural or synthetic sources. The specific fish attractant substance is not critical, and in fact a variety or combination of such materials may be provided in different lures, depending upon the type of fish being sought, the conditions and fishing environment, etc. Alternatively, the user may add any desired fish attractant after purchasing the lure.

In use, the lure 101 is molded and cured with the desired amount of porous particulate, such as calcium carbonate, interspersed in the polymeric base, such as plastisol. In a particular embodiment, the weight ratio of the porous particles to the polymeric base is 3:4 to result in a desirable sink rate of 1 ft/sec and a sufficient capacity for the fish attractant. In another particular embodiment, a weight ratio of 1:4 is used to result in a desirable sink rate of 0.5 ft/sec and a sufficient capacity for the fish attractant. The fish attractant is applied to the lure 101 by soaking or dipping the lure in a solution containing the attractant, or by spraying the attractant on the lure. The attractant may be applied before packaging and distribution of the lure. Alternatively, the attractant is applied by the user. The latter allows the user to decide which attractant to use with the lure prior to use, rather than being constrained to the attractant and shape combinations provided by a manufacturer.

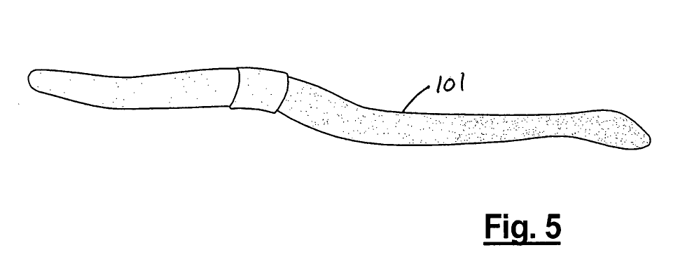

In a further particular embodiment, the lure 101 comprises an uneven distribution of porous particles, as shown in FIG. 5. The lure 101 includes a portion that is impregnated with the particulate calcium carbonate and a portion that is free of calcium carbonate. Attractant may be added to the part by immersing the body or portion of the body in a solution of attractant.

In an alternative embodiment, liquid fish attractant-containing microcapsules are provided in addition to the porous particles. The microcapsules can also contain a particulate and/or liquid component(s), to visually appeal to the fish being sought. Such visual fish attractants can include particulate “sparkles” to simulate fish scales released from natural bait fish when excited, and liquid soluble fear-simulating substances to simulate fear reactions occurring in natural bait fish. Other components offering visual attractant appeal to target fish are phosphorescent and/or fluorescent dye(s) and pigments, and other dyes and coloring agents enhancing visual appeal.

Suitable chemically hardenable, water-soluble coacervatable microencapsulating materials useful to form the microcapsule solid wall material by coacervation, permitting the incorporation of liquid fish attractant in particulate form in the binder, include natural and synthetic polymers, such as: gum arabic, carboxymethyl cellulose, polyvinyl alcohol, methyl cellulose, gelatin, hydroxypropyl cellulose and like materials. The term “coacervation,” as used herein, means that the microencapsulation takes place by phase separation wherein at least two reactants which are in solution combine to form a hydrophilic composition or compound which surrounds each water-insoluble droplet of fish attractant oil.

Suitable chemical hardening agents which can be used to chemically harden the capsule wall material include, but are not necessarily limited to, the following: glutaraldehyde, formaldehyde, and other cross-linking agents well known in the art.

The polymeric binder component used in this invention enables the microencapsulated component to remain reasonably stable in a tacky, viscous state until molded into the appropriate shaped fishing lures. This polymeric binder component constitutes a continuous phase of water-soluble dissolved polymer, e.g., any one, or more, of the natural or synthetic polymers previously set forth above in conjunction with those coacervatable materials and includes gum arabic, carboxymethyl cellulose, polyvinyl alcohol, methyl cellulose, hydroxypropyl cellulose, gelatin, etc.

The continuous phase polymeric binder can include a taste enhancer(s), e.g., salt (NaCl), amino acids, and naturally occurring products.

Such water-soluble binder material can also include: one or more of the above fish-attractant scents; combinations of similar or dissimilar scents; sparkles, dyes, pigments and fear reaction simulating visual attractant materials, etc. When such materials are incorporated in the water-soluble binder, they offer comparatively immediate enticement to the fish upon presentation of the lure in the water.

The microencapsulated liquid fish attractant containing component can include other adjuvant materials as well, e.g., wetting agents; phase inducers promoting coacervation; viscosity control enhancing agents; fragrant oil extenders; polymer solubility enhancers; inverse solubility control agents (to control solubility in relation to the temperature of the water in which fishing is taking place); pH control agents, etc.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

1. An artificial fishing lure comprising a cured polymer having a fish-attracting shape made from a composite material comprising:
a polymeric base material; and
a portion of porous particles that are dispersed throughout said polymeric body.

2. The lure according to claim 1, wherein the weight ratio of the porous particles to the polymeric base material is in the range of 0.01:1 to 8:1.

3. The lure according to claim 1 wherein said porous particles are imbibed with a gustatory stimulant.

4. The lure according to claim 1 wherein said porous particles are imbibed with a fish attractant.

5. The lure according to claim 4 wherein said attractant is water soluble.

6. The lure according to claim 5 wherein said attractant is oil soluble.

7. The lure according to claim 4 wherein the attractant is imbibed in the porous particles prior to forming said lure.

8. The lure according to claim 7, wherein the lure is formed by a process selected from the group consisting essentially of rotational molding, injection molding, hand pouring, compression molding, transfer molding, thermoforming, and extrusion.

9. the lure according to claim 4 wherein the attractant is imbibed in the porous particles by a user prior to use of said lure.

10. The lure according to claim 1 wherein said polymer is a plastisol.

11. The lure according to claim 1 wherein said porous particles comprise a material selected from the group consisting essentially of calcium carbonate, clays, vermiculite, pumice, sponge, and polymers composed of polyacrylate or polyacrylamide and their respective salt species.

12. The lure according to claim 1 wherein said polymer is in the shape selected from the group consisting essentially of a worm, crayfish, minnow, bloodworm, squid, crab, shrimp, frog, lizard, and frog chunk.

13. An artificial fishing lure comprising:
at least one hook portion; and
a body portion, wherein said body portion comprises plastisol impregnated with calcium carbonate, wherein the weight ratio of the calcium carbonate to plastisol is in the range of 0.01:1 to 8:1.

14. The fishing lure of claim 13 further comprising an attractant wherein said attractant is mixed with the calcium carbonate prior to the incorporation of the calcium carbonate into said plastisol.

15. The fishing lure of claim 13 further comprising an attractant wherein said attractant has been mixed with the calcium carbonate after the molding of said body portion.

16. The fishing lure of claim 13 wherein the percentage calcium carbonate in the plastisol is 25 wt %, thereby providing a sink rate of 0.5 ft/sec.

17. The fishing lure of claim 13 wherein said the percentage calcium carbonate in the plastisol is 75 wt %, thereby providing a sink rate of 1 ft/sec.

18. An aquatic bait for long term underwater use in attracting fish and the like by sustained release of a fish-attracting scent comprising:
a plastisol-derived body molded into a fish-attracting shape and having a porous particulate base as a carrier;
an attractant distributed throughout and on the surface of the article body;
wherein the attractant is introduced to the porous particulate carrier by immersing the body in a solution containing the attractant.

19. The article of claim 18 herein the attractant is chosen from the group consisting of cod liver oil, menhaden oil, fish oils, garlic, worm extract, crayfish extract, and synthetic scents

20. The article of claim 18 wherein the porous particulate base comprises a material selected from the group consisting essentially of calcium carbonate, clays, vermiculite, pumice, sponge, and polymers composed of polyacrylate or polyacrylamide and their respective salt species.

21. The article of claim 18 wherein the ratio by weight of the attractant to the porous particulate is in the range 0.01:1 to 1:1.
